(19) United States
(12) Patent Application Publication
(10) Pub. No.: US 2024/0375129 A1
(43) Pub. Date: Nov. 14, 2024

(54) SPRAYER NOZZLE AND NOZZLE DIFFUSER SYSTEM AND METHOD

(71) Applicant: Pentair Flow Technologies, LLC, Delavan, WI (US)

(72) Inventors: Jason Jirjis, Plymouth, MN (US); Erich Grutzner, Mounds View, MN (US)

(21) Appl. No.: 18/658,032

(22) Filed: May 8, 2024

Related U.S. Application Data
(60) Provisional application No. 63/500,841, filed on May 8, 2023.

(51) Int. Cl. B05B 1/26; B05B 1/04

(52) U.S. Cl. CPC B05B 1/262; B05B 1/046

(57) ABSTRACT

A nozzle including an elongate body and a nozzle outlet subassembly. The elongate body includes a first passageway. The nozzle outlet subassembly is disposed at least partially within the first passageway. The nozzle outlet subassembly includes a nozzle terminal and a diffuser. The nozzle terminal defines a second passageway and a spray opening. The diffuser defines a diffusion opening that is proximate the spray opening.

### CROSS-REFERENCE TO RELATED APPLICATIONS

This application claims priority to U.S. Provisional Patent Application No. 63/500,841 filed May 8, 2023, the entire disclosure of which is incorporated herein by reference.

### BRIEF SUMMARY

This disclosure generally relates to sprayer nozzles. More specifically, the disclosure relates to a sprayer nozzle equipped with an upstream nozzle diffuser disposed proximate to a nozzle outlet.

### BACKGROUND

Conventional sprayer nozzles, such as nozzles used in an agricultural sprayer, are provided in the form of a housing defining a fluid pathway extending therethrough and a nozzle outlet where fluid is dispersed. The fluid pathway and nozzle outlet are designed to sprayably disperse a fluid, e.g., fertilizers, herbicides, pesticides, etc., over an area of land. It can be difficult to spray a target area of land without the fluid inadvertently traveling to a second unintended area. The unintended spraying/traveling of fluid to adjacent areas is commonly referred to as drift.

Drift is undesirable and may create a variety of risks. As such, there is a need for an improved sprayer nozzle that is designed to further reduce drift, increase spray angle stability, and more precisely disperse a fluid in a desired and more defined pattern.

### SUMMARY

Some embodiments provide a nozzle including an elongate body and a nozzle outlet subassembly. The elongate body includes a first passageway. The nozzle outlet subassembly is disposed at least partially within the first passageway. The nozzle outlet subassembly includes a nozzle terminal and a diffuser. The nozzle terminal defines a second passageway and a spray opening. The diffuser defines a diffusion opening that is proximate the spray opening.

In some forms, the diffuser includes a plate with a diffusion opening extending through the plate. A surface of the plate is positioned perpendicular to an axis that extends along at least a portion of the elongate body, through the plate, and through the spray opening.

In some embodiments, the diffusion opening extends through the plate parallel to the axis.

In some embodiments, the diffuser includes an extender that extends axially from the plate, and the diffuser is positioned in the nozzle outlet subassembly such that the extender extends away from the nozzle terminal.

In some embodiments, the diffusion opening is one of a plurality of diffusion openings defined in the diffuser, the plurality of diffusion openings being disposed about an axis defined by the elongate body and extending through the spray opening.

In some embodiments, one or more of the plurality of diffusion openings has a cross-section that is one of crescent-shaped, semi-circular, or circular.

In some embodiments, one or more of the plurality of diffusion openings is radially offset from the axis.

In some embodiments, the diffuser includes a lobe region extending radially from a central region, and the lobe region and the central region define a shoulder.

In some embodiments, the surface of the plate is seated into the nozzle terminal to orient the diffusion opening relative to the spray opening.

Some embodiments provide a nozzle outlet coupled to a nozzle. The nozzle outlet includes a nozzle terminal and a diffuser. The nozzle terminal defines a spray opening and an axis extending through the spray opening. The diffuser is provided in the form of a plate. A diffusion opening extends through the plate and parallel to the axis opening.

In some embodiments, a surface of the plate is positioned perpendicular to the axis.

In some embodiments, the axis is a first axis, the diffusion opening is one of a plurality of diffusion openings aligned along the surface of the plate to form a second axis, and the first axis is substantially perpendicular to the second axis.

In some embodiments, the diffuser includes a flat side and the flat side mates with the nozzle terminal to orient the diffusion opening relative to the spray opening.

In some embodiments, when the nozzle outlet is viewed from a perspective that is normal to the surface of the plate, an outer circumference of the diffusion opening does not overlap with an outer circumference of the spray opening.

In some embodiments, the diffusion opening has a circular cross-section with a diameter equal to or less than 2 mm.

Some embodiments provide a nozzle including an elongate body, a pre-orifice regulator, a nozzle terminal, and a diffuser. The pre-orifice regulator includes a pre-orifice opening configured to regulate fluid flow. The pre-orifice regulator is coupled to a first end of the elongate body. The nozzle terminal is coupled to a second end of the elongate body, and the nozzle terminal defines a spray opening. The diffuser is coupled to the nozzle terminal. The diffuser defines a diffusion opening. The diffuser is positioned within the elongate body between the pre-orifice regulator and the spray opening.

In some embodiments, a cross-sectional area of the diffusion opening is larger than a cross-sectional area of the pre-orifice opening.

In some embodiments, the nozzle terminal includes bayonet lobe that mates with the elongate body to align the spray opening relative to the elongate body.

In some embodiments, an axis is defined by the elongate body and extends through the spray opening, and the diffusion opening extends perpendicular to the axis.

In some embodiments, an axis is defined by the elongate body and extends through the spray opening, and the diffusion opening extends parallel to the axis.

### BRIEF DESCRIPTION OF THE DRAWINGS

FIG. 1 is a cross-sectional view of a sprayer nozzle according to an embodiment;

FIG. 2 is a top plan view of the sprayer nozzle of FIG. 1, with some portions rendered translucently and some portions removed for clarity;

FIG. 3 is an isometric view of a first nozzle outlet subassembly of the sprayer nozzle of FIG. 1 comprising a first nozzle terminal and a first diffuser;

FIG. 4 is a bottom plan view of the first nozzle outlet subassembly of FIG. 3;

FIG. 5 is a bottom plan view of the first diffuser of the first nozzle outlet subassembly of FIGS. 3 and 4;

FIG. 6 is an isometric view of a second nozzle outlet subassembly comprising the first nozzle terminal of FIGS. 3 and 4 and a second diffuser;

FIG. 7 is a top plan view of the second diffuser of the second nozzle outlet subassembly of FIG. 6;

FIG. 8 is a top plan view of a third diffuser usable with the first nozzle terminal of FIGS. 3 and 4;

FIG. 9 is a top plan view of a fourth diffuser usable with the first nozzle terminal of FIGS. 3 and 4;

FIG. 10 is a top plan view of a fifth diffuser usable with the first nozzle terminal of FIGS. 3 and 4; and

FIG. 11 is a top plan view of a sixth diffuser usable with the first nozzle terminal of FIGS. 3 and 4.

Before explaining the disclosed embodiments of the present invention in detail, it is to be understood that the invention is not limited in its application to the details of the particular arrangements shown, because the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the phraseology and terminology used herein is for the purpose of description and should not be regarded as limiting. For example, the use of “including,” “comprising,” or “having” and variations thereof herein is meant to encompass the items listed thereafter and equivalents thereof, as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings but can also refer to communicative, electrical, or fluidic couplings.

Sprayer nozzles designed to minimize drift reduction commonly have a tradeoff between drift reduction, spray pattern angle, and spray pattern concentration. Here, adding a diffuser close to the spray opening of the nozzle disperses the flow of fluid therethrough and the concentration of energy within the nozzle. In turn, dispersing the flow of fluid and concentrating the energy within the nozzle reduces drift, stabilizes the spray angle, and evenly concentrates the spray pattern.

This disclosure contemplates placing a diffuser or the like in close proximity to a nozzle spray outlet or spray opening of a sprayer nozzle. Unlike in conventional nozzle assemblies, the diffuser disclosed herein is placed downstream of a pre-orifice regulator and close to the spray opening of the nozzle. In some instances, the diffusers described herein may be positioned perpendicularly with respect to the spray opening to disrupt fluid flow and energy. In other instances, the diffusers described herein may be used parallel with respect to the spray opening to control a spray pattern shape.

When the diffuser is oriented perpendicularly with respect to the nozzle spray opening, the flow may be directed or deflected toward the side walls of the nozzle, which disrupts the fluid flow and, hence, the fluid energy. The disruption reduces drift and produces a more stable cumulative fluid output volume. When the diffuser is oriented parallel with respect to the nozzle spray opening, fluid may exit the nozzle spray opening in a controlled specified manner to control the fluid concentration across a spray pattern. With the diffuser disposed close to the nozzle spray opening, a single spray pattern may include multiple curves of fluid droplets. Often, spray pattern curves at least partially determine how nozzle assemblies are spaced on a tractor's boom. When the spray pattern includes multiple curves, the curves of the spray pattern may be used for crop spacing in lieu of changing the spacing of control valves on the boom.

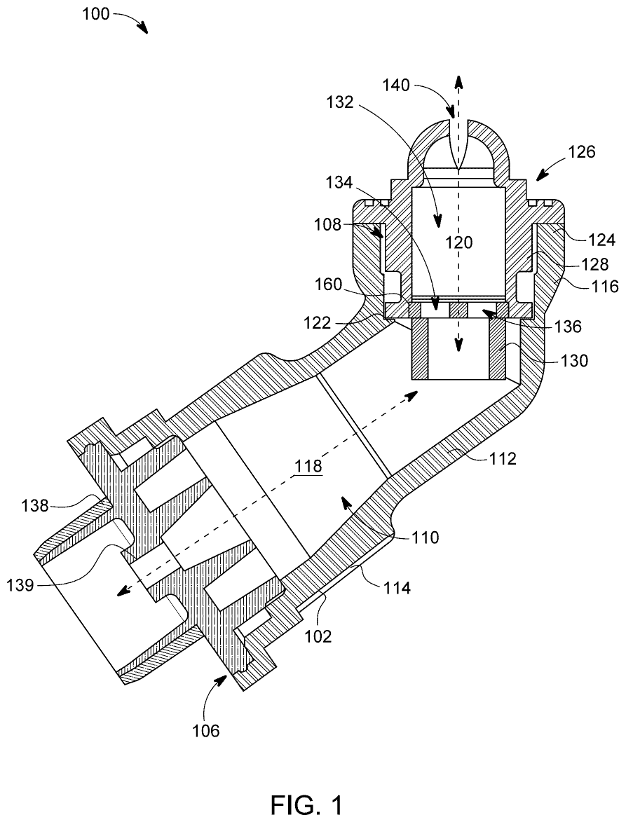

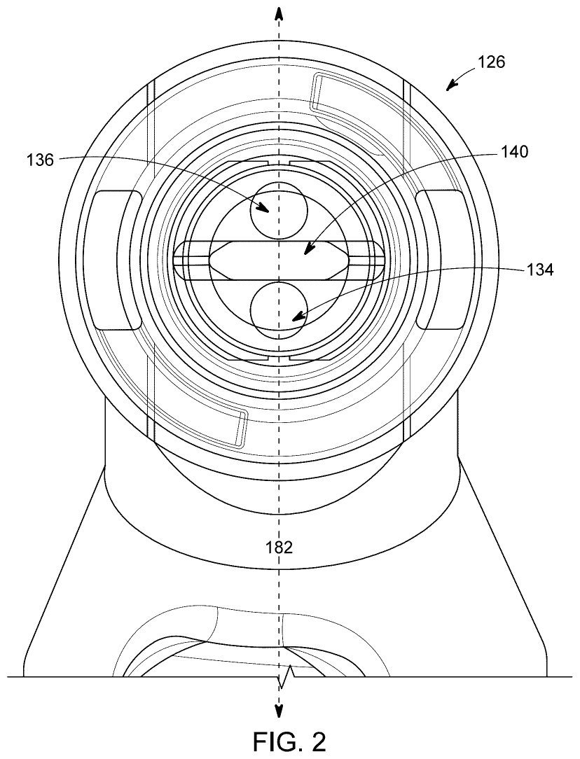

FIGS. 1 and 2 illustrate an advanced sprayer nozzle 100 according to one embodiment. The sprayer nozzle 100 is defined by an elongate, generally L-shaped body 102 defining a first passageway 110 extending therethrough. The first passageway 110 includes a first opening 106 at a first end of the body 102 and a second opening 108 at a second end of the body 102. The first passageway 110 is defined by a circumferential wall 112 having a first portion 114 and a second portion 116. The first portion 114 defines a first axis 118, and the second portion 116 defines a second axis 120, whereby the first axis 118 is non-parallel to the second axis 120. In some instances, the first axis 118 and the second axis 120 form an angle greater than about 90 degrees. In other instances, the angle between the first axis 118 and the second axis 120 is greater than about 120 degrees. The circumferential wall 112 is further defined by an inner shoulder 122 and an outer shoulder 124 at a distal end thereof. In some instances, at least part of the inner shoulder 122 can be formed adjacent to the inflection point between the first portion 114 and the second portion 116 of the circumferential wall 112.

Still referring to FIG. 1, the sprayer nozzle 100 further includes a first nozzle outlet subassembly 126 provided in the form of a nozzle terminal 128 and a first diffuser 130. The first nozzle outlet subassembly 126 can be engaged with and supported by the second portion 116 of the circumferential wall 112 adjacent to the second opening 108 of the first passageway 110. In some embodiments, the first nozzle outlet subassembly 126 is disposed at least partially within the first passageway 110 in an interference fit, snap fit, or the like. In some forms, the first nozzle outlet subassembly 126 abuts the inner shoulder 122 of the circumferential wall 112, and the first diffuser 130 is positioned within the first nozzle outlet subassembly 126 and adjacent to the inner shoulder 122. The nozzle terminal 128 further defines a second passageway 132 that is in fluid communication with the first passageway 110. The nozzle terminal 128 includes a spray opening 140 at a distal end, and the first diffuser 130 includes a first diffusion opening 134 and a second diffusion opening 136, which will be explained in more detail below.

As shown in FIG. 1, at the first end of the body 102, a pre-orifice regulator 138 is fitted into the first opening 106. The pre-orifice regulator 138 can be coupled to the body 102 via any number of fastening means, such as by way of threaded coupling, a press fit or interference coupling, an adhesive, solvent welding, and the like. The pre-orifice regulator 138 includes a pre-orifice opening 139 that regulates the flow of fluid into the first passageway 110.

FIG. 2 illustrates a partial view of the sprayer nozzle 100 from a perspective looking toward the first nozzle outlet subassembly 126 and into the spray opening 140. The perspective of FIG. 2 is also normal to a back surface of the first diffuser 130 and directed into the first diffusion opening 134 and the second diffusion opening 136 of the first diffuser 130. As shown, from the perspective shown in FIG. 2, the outer circumferences of the diffusion openings 134, 136 do not overlap with the outer circumference of the spray opening 140. For example, if fluid was flowing in a straight path through either one of the diffusion openings 134, 136, parallel to the second axis 120 and toward the spray opening 140, the fluid would need to change direction at least partially in order to flow out of the spray opening 140. In some forms, the outer circumferences of the diffusion openings 134, 136 may partially overlap with the outer circumference of the spray opening 140 from the perspective of FIG. 2. The offset design of the diffusion openings 134, 136 and the spray opening 140 assists in disrupting fluid flow and dispersing energy concentration before the fluid exits the spray opening 140.

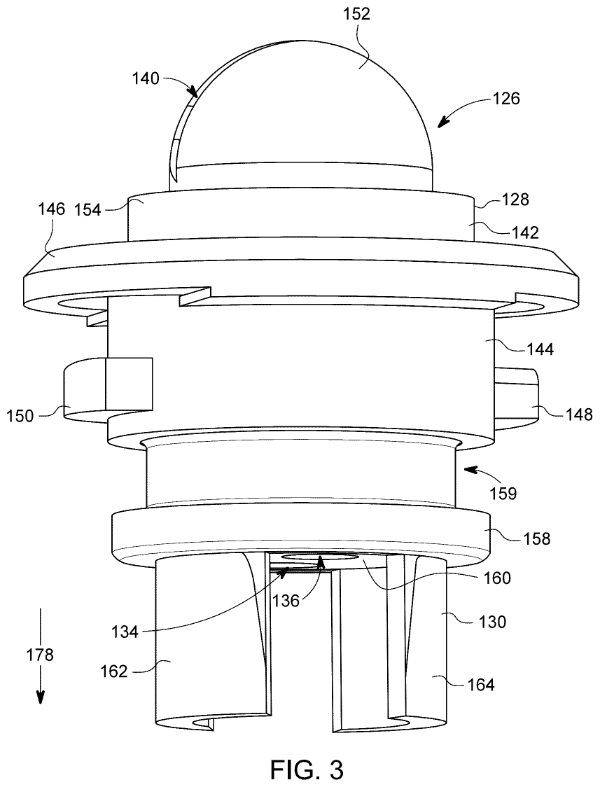

FIG. 3 further illustrates various details of the first nozzle outlet subassembly 126. For example, the nozzle terminal 128 includes a terminal body 142 defined by a circumferential wall 144, a flange 146, a first bayonet lobe 148, a second bayonet lobe 150, and an end cap 152. The flange 146, the first bayonet lobe 148, and the second bayonet lobe 150 extend radially outwardly from the circumferential wall 144. In some forms, the flange 146 extends around the entire circumference of the terminal body 142. The first bayonet lobe 148 and the second bayonet lobe 150 protrude outwardly from the circumferential wall 144 and are disposed substantially opposite one another.

The end cap 152 protrudes upwardly from a first end 154 of the circumferential wall 144 and defines the spray opening 140. In some embodiments, the end cap 152 is hemispherical. In some embodiments, the spray opening 140 is provided in the form of a notch that is substantially v-shaped, as shown in FIGS. 1 and 2. The circumferential wall 144 has a second end 158 and includes a groove 159 that is disposed between the flange 146 and the second end 158. In some embodiments, the first bayonet lobe 148 and the second bayonet lobe 150 are disposed between the groove 159 and the flange 146. Additionally, the first bayonet lobe 148 and the second bayonet lobe 150 mate with the elongate body 102 (shown in FIG. 1) to align the spray opening 140 along the elongate body 102 and secure the first nozzle outlet subassembly 126 to the elongate body 102 at the second opening 108.

In some forms, the nozzle terminal 128 is aligned with and defines the second axis 120. As such, the second axis 120 extends through the spray opening 140 and the first diffuser 130. In some embodiments, the second axis 120 extends through a center point of the spray opening 140 and a center point of the first diffuser 130. Accordingly, the second axis 120 extends along at least a portion of the body 102 and the second passageway 132.

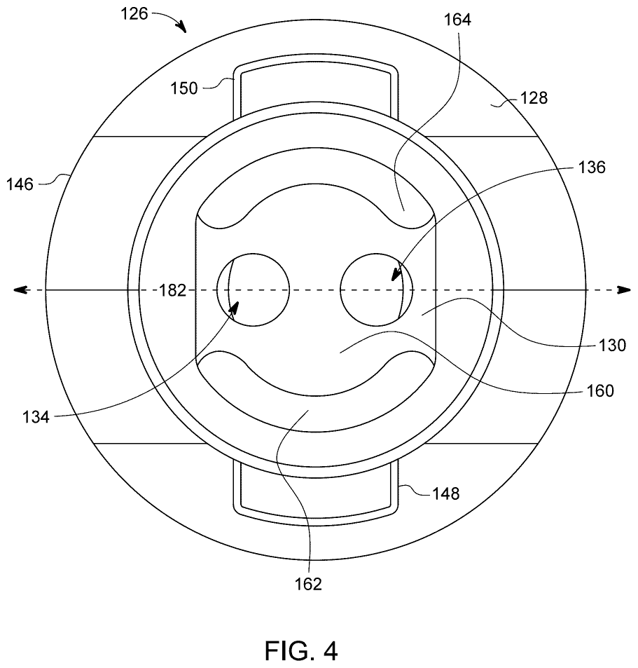

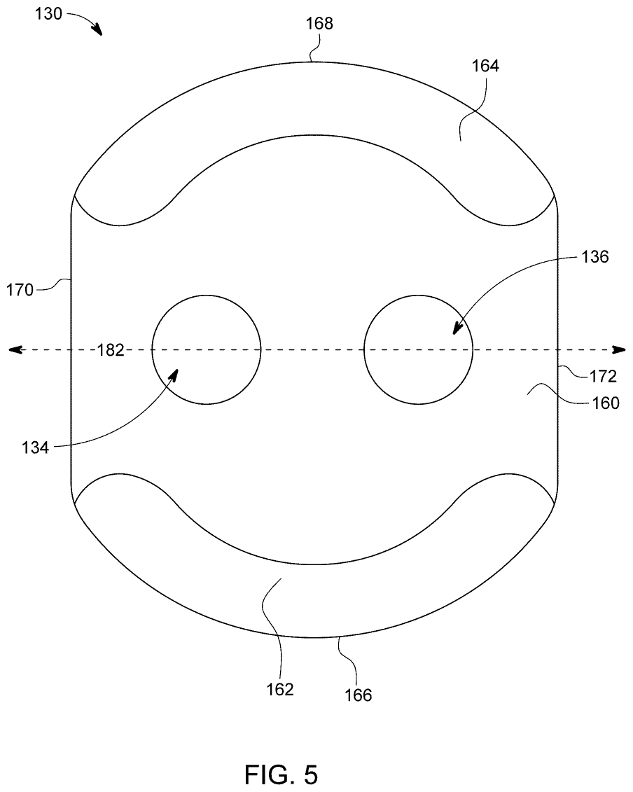

As shown in FIGS. 1-5, the first diffuser 130 includes a plate 160, a first extender 162, and a second extender 164. Turning specifically to FIG. 5, the plate 160 includes a first side 166, a second side 168, a third side 170, and a fourth side 172. The first side 166 is positioned substantially opposite the second side 168, and the third side 170 is positioned substantially opposite the fourth side 172. In some embodiments, the first side 166 and the second side 168 are rounded. In some embodiments, the third side 170 and the fourth side 172 are substantially flat or planar. Thus, in some embodiments, a front and/or back surface of the plate 160 is provided in the form of a discorectangle, obround, or stadium. The third side 170 and the fourth side 172 are substantially flat, which can help orient the first diffusion opening 134 and the second diffusion opening 136 relative to the spray opening 140 as the first diffuser 130 is seated into the nozzle terminal 128. In some forms, once seated into the nozzle terminal 128, the front and/or back surface of the plate 160 are positioned substantially perpendicularly to the second axis 120.

The plate 160 defines a thickness dimension between the front surface and the back surface through which the first diffusion opening 134 and the second diffusion opening 136 extend. In some embodiments, the first diffusion opening 134 and/or the second diffusion opening 136 each have a cross-section that is circular in shape, thus providing a cylindrical through-hole in the plate 160. In some forms, the first diffusion opening 134 and the second diffusion opening 136 extend through the plate 160 substantially parallel to the second axis 120. Although the second axis 120 extends through and is generally aligned with the spray opening 140, here, the first diffusion opening 134 and the second diffusion opening 136 are radially offset from second axis 120. Accordingly, the first diffusion opening 134 and the second diffusion opening 136 are disposed on opposing sides of and/or about the second axis 120. Thus, the spray opening 140 is positioned along the second axis 120 laterally between the first diffusion opening 134 and the second diffusion opening 136. In some forms, the first diffusion opening 134 and the second diffusion opening 136 are aligned on the front and/or back surface of the plate 160 to form a third axis 182. In some instances, the third axis 182 is substantially perpendicular to the second axis 120.

Further, the first diffusion opening 134 and the second diffusion opening 136 are disposed in the plate 160 between the first extender 162 and the second extender 164. The first extender 162 and the second extender 164 are positioned substantially opposite one another and extend away from the plate 160 in a first direction 178. The first extender 162 is adjacent the first side 166 of the plate 160, and the second extender 164 is adjacent the second side 168 of the plate 160. In some embodiments, the first extender 162 and the second extender 164 are arcuate in shape.

The first diffuser 130 can be disposed within or at one end of the second passageway 132 of the nozzle terminal 128. In some forms, the first diffuser 130 is positioned toward an end of the nozzle terminal 128 that is opposite the spray opening 140. In some forms, the first diffuser 130 is positioned adjacent the spray opening 140. It should be appreciated that when the first diffuser 130 is installed in the nozzle terminal 128, the first diffusion opening 134 and the second diffusion opening 136 are vertically offset from the spray opening 140 by the circumferential wall 144. The first diffusion opening 134 and the second diffusion opening 136 are proximate to the spray opening 140.

The first opening 106 is in fluid communication with the spray opening 140 via the pre-orifice opening 139, the first passageway 110, the first diffusion opening 134 and the second diffusion opening 136, and the second passageway 132. In operation, the first opening 106 and the pre-orifice opening 139 are upstream of the first diffusion opening 134, the second diffusion opening 136, and the spray opening 140. Additionally, in operation, the first diffusion opening 134 and the second diffusion opening 136 are upstream of the spray opening 140. Further, the first diffuser 130 and, thus, the first diffusion opening 134 and the second diffusion opening 136, is positioned within the body 102 between the pre-orifice regulator 138 and the spray opening 140.

In some forms, the cross-sectional area of the pre-orifice opening 139 is equal to or larger than the cross-sectional area of the first diffusion opening 134 and/or the second diffusion opening 136. In some forms, the cross-sectional area of the pre-orifice opening 139 is equal to or larger than the combined cross-sectional area of the first diffusion opening 134 and the second diffusion opening 136. In this way, the first diffuser 130 disrupts fluid flow and disperses energy concentration before the fluid exits the spray opening 140 without reducing or restricting the flow rate or flow volume of fluid through the sprayer nozzle 100. In some forms, one or both of the first diffusion opening 134 and the second diffusion opening 136 have a circular cross-section with a diameter equal to or less than 2 mm.

In some embodiments, the first diffuser 130 is positioned parallel to the second axis 120 rather than perpendicular to the second axis 120. Thus, the first diffusion opening 134 and the second diffusion opening 136 can extend through the plate 160 substantially perpendicular to the second axis 120, the third axis 182 can be substantially parallel to the second axis 120, and the front and/or back surface of the plate 160 can be positioned substantially parallel to the second axis 120.

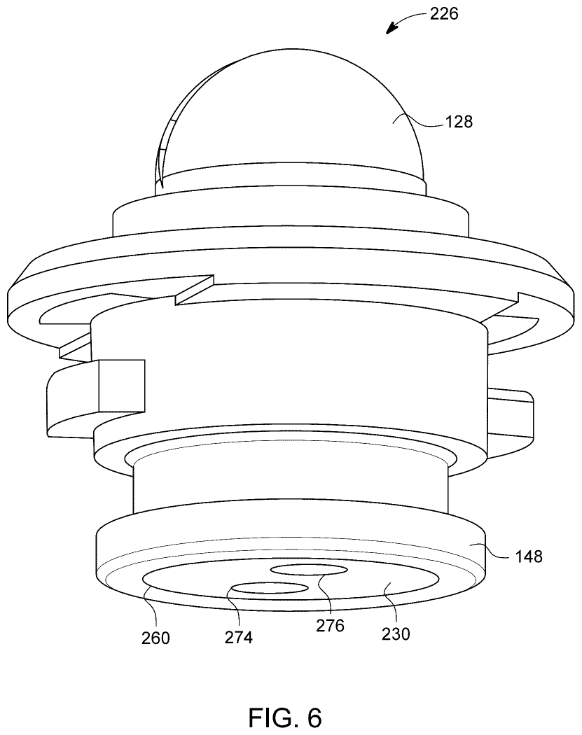

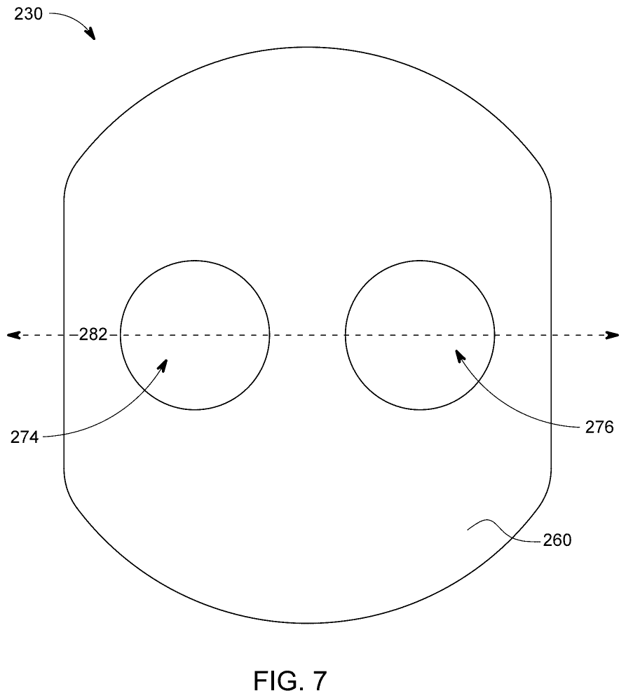

As shown in FIGS. 6 and 7, a second nozzle outlet subassembly 226 is depicted and has a substantially similar structure to that of the first nozzle outlet subassembly 126. The second nozzle outlet subassembly 226 includes the nozzle terminal 128 described in connection with FIG. 3 and a second diffuser 230. The second diffuser 230 engages the nozzle terminal 128 at the second end 158. The second diffuser 230 includes a plate 260, which is similar to the plate 160 except without the first and second extenders 162, 164. The plate 260 also includes a first diffusion opening 274 and a second diffusion opening 276 that are aligned to form the third axis 282 (see FIG. 7).

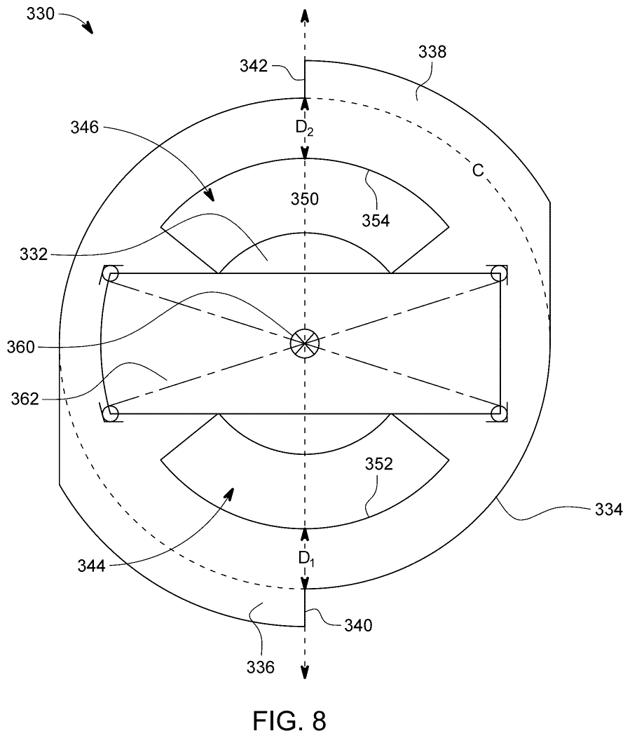

Referring to FIG. 8, a third diffuser 330 is illustrated. The third diffuser 330 includes a generally circular plate 332. The plate 332 is defined by a central region 334, a first lobe region 336, and a second lobe region 338. The first lobe region 336 and the second lobe region 338 extend radially outwardly from the central region 334. The first lobe region 336 and the second lobe region 338 are substantially opposite one another. The first lobe region 336 and the central region 334 define a first shoulder 340. The second lobe region 338 and the central region 334 define a second shoulder 342. In some embodiments, the first shoulder 340 and the second shoulder 342 are coplanar with one another. The central region 334 defines a first diffusion opening 344 and a second diffusion opening 346 that extend through a thickness dimension of the plate 332 and are substantially opposite one another. In some embodiments, the first diffusion opening 344 and/or the second diffusion opening 346 are arcuate in shape. Thus, in some embodiments, the first diffusion opening 344 and/or the second diffusion opening 346 each have a cross-section that is crescent-shaped.

Still referring to FIG. 8, the third diffuser 330 defines a first axis 350. The central region 334 has a circumference C. The first diffusion opening 344 is partially defined by a first outer perimeter side 352 and the second diffusion opening 346 is partially defined by a second outer perimeter side 354. The first axis 350 is colinear with the first shoulder 340 and the second shoulder 342 and traverses medially through the first diffusion opening 344 and the second diffusion opening 346. A first distance D₁ is defined between the first outer perimeter side 352 and the circumference C, and a second distance D₂ is defined between the second outer perimeter side 354 and the circumference C. In some forms, the first shoulder 340 is shorter than the first distance D₁, and the second shoulder 342 is shorter than the second distance D₂.

The third diffuser 330 further defines a second axis 360 extending toward and away from the viewer of FIG. 8. The third diffuser 330 also includes an extender 362. The extender 362 extends longitudinally away from a front surface of the plate 332 along the second axis 360 toward the viewer of FIG. 8. The extender 362 is disposed between the first diffusion opening 344 and the second diffusion opening 346. In some embodiments, the extender 362 is pyramidal in shape. Similar to the arrangement shown in FIG. 3 with the first extender 162 and the second extender 164 of the first diffuser 130 extending away from the nozzle terminal 128, here, the third diffuser 330 can also be arranged in the first nozzle outlet subassembly 126 in place of the first diffuser 130 such that the extender 362 extends away from the nozzle terminal 128. The first diffusion opening 344 and the second diffusion opening 346 are disposed on opposing sides of and/or about the second axis 360.

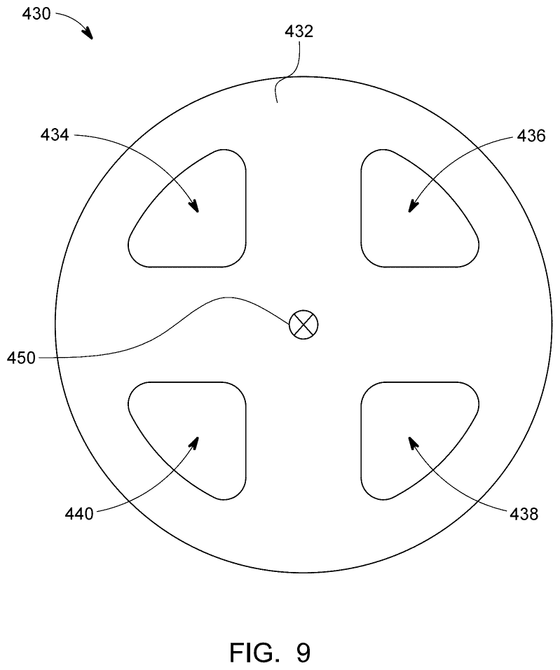

Referring to FIG. 9, a fourth diffuser 430 is illustrated. Here, the fourth diffuser 430 is provided in the form of a circular plate 432. The plate 432 defines a first diffusion opening 434, a second diffusion opening 436, a third diffusion opening 438, and a fourth diffusion opening 440 that extend through a thickness dimension of the plate 432. The plate 432 defines an axis 450 that passes medially through the plate 432 and extends toward and away from the viewer of FIG. 9. In some embodiments, the first diffusion opening 434, the second diffusion opening 436, the third diffusion opening 438, and the fourth diffusion opening 440 are radially symmetrical about the axis 450 and are each provided in the form of a right triangle having rounded corners and a rounded hypotenuse. In some embodiments, the first diffusion opening 434, the second diffusion opening 436, the third diffusion opening 438, and the fourth diffusion opening 440 are arranged such that the rounded hypotenuse is adjacent the outer circumference of the circular plate 432.

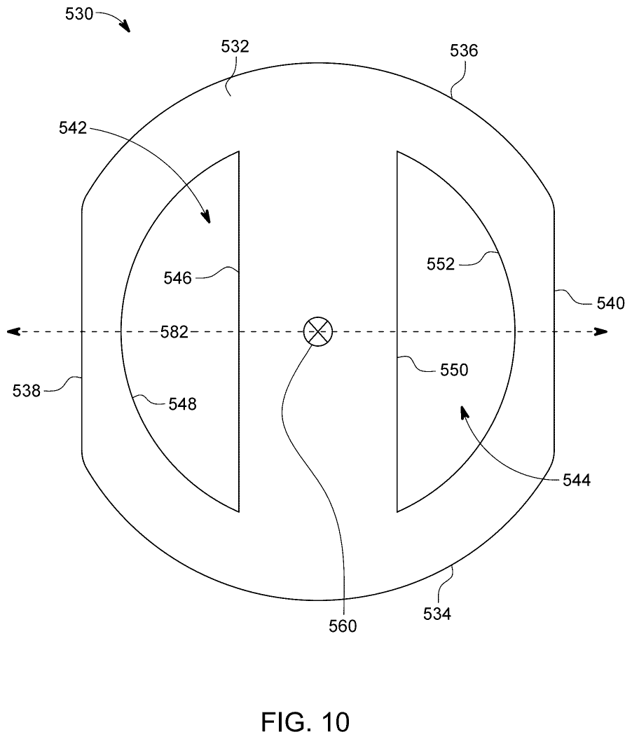

Referring to FIG. 10, a fifth diffuser 530 is illustrated. Here, the fifth diffuser 530 is provided in the form of a plate 532. The plate 532 includes a first side 534, a second side 536, a third side 538, and a fourth side 540. The first side 534 and the second side 536 are substantially opposite one another. The third side 538 and the fourth side 540 are substantially opposite one another. In some embodiments, the first side 534 and the second side 536 are rounded. In some embodiments, the third side 538 and the fourth side 540 are substantially flat, or planar.

The plate 532 defines a first diffusion opening 542 and a second diffusion opening 544 extending through a thickness dimension of the plate 532. The first diffusion opening 542 and the second diffusion opening 544 are positioned substantially opposite one another. The first diffusion opening 542 is defined by a first inner perimeter side 546 and a first outer perimeter side 548, and the second diffusion opening 544 is defined by a second inner perimeter side 550 and a second outer perimeter side 552. In some embodiments, the first inner perimeter side 546 and the second inner perimeter side 550 are substantially flat or planar. In some embodiments, the first outer perimeter side 548 and the second outer perimeter side 552 are rounded. Thus, in some embodiments, the first diffusion opening 542 and the second diffusion opening 544 are semi-circular in shape. The plate 532 defines a first axis 560 that passes medially through the plate 532 and extends toward and away from the viewer of FIG. 10. The first diffusion opening 542 and the second diffusion opening 544 are disposed on opposing sides of and/or about the first axis 560. Additionally, the first diffusion opening 542 and the second diffusion opening 544 are aligned to form a second axis 582 along a surface of the plate 532, the second axis 582 being substantially perpendicular to the first inner perimeter side 546 and the second inner perimeter side 550.

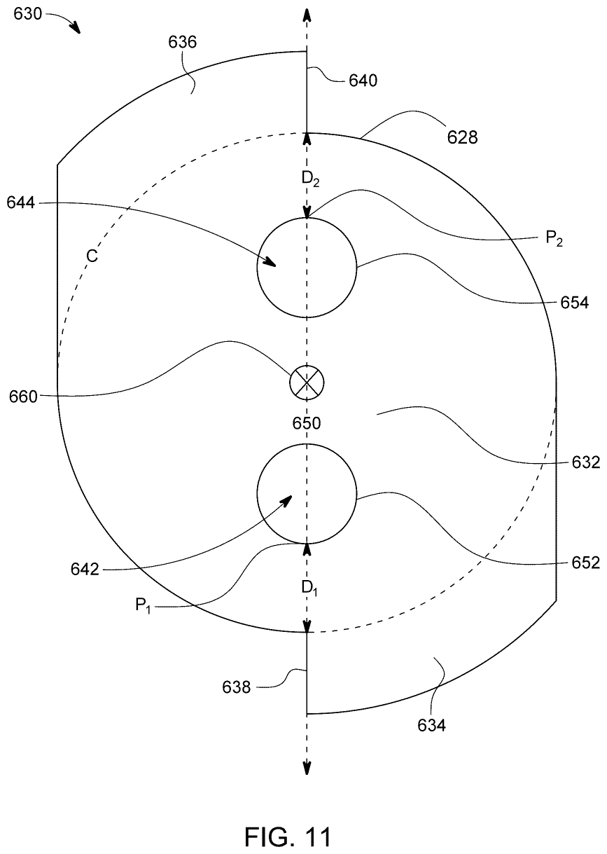

Referring next to FIG. 11, a sixth diffuser 630 is illustrated. Here, the sixth diffuser 630 is provided in the form of a plate 632. The plate 632 includes a central region 628, a first lobe region 634, and a second lobe region 636. The first lobe region 634 and the second lobe region 636 extend radially outwardly from the central region 628. The first lobe region 634 and the second lobe region 636 are substantially opposite one another. The first lobe region 634 and the central region 628 define a first shoulder 638 and the second lobe region 636 and the central region 628 define a second shoulder 640. In some embodiments, the first shoulder 638 and the second shoulder 640 are coplanar with one another. The central region 628 defines a first diffusion opening 642 and a second diffusion opening 644. The first diffusion opening 642 is positioned substantially opposite the second diffusion opening 644. In some embodiments, the first diffusion opening 642 and/or the second diffusion opening 644 are circular in shape and form a substantially cylindrical through-hole through the plate 632.

Referring still to FIG. 11, the sixth diffuser 630 further defines a first axis 650 bisecting the plate 632. The central region 628 has the circumference C. The first diffusion opening 642 is defined by a first perimeter 652. The second diffusion opening 644 is defined by a second perimeter 654. The first perimeter 652 has a first outermost point P₁. The second perimeter 654 has a second outermost point P₂. The first axis 650 is colinear with the first shoulder 638 and the second shoulder 640. The first axis 650 traverses medially through the first diffusion opening 642 and the second diffusion opening 644. A first distance D₁ is defined between the first outermost point P₁ and the circumference C, and second distance D₂ is defined between the second outermost point P₂ and the circumference C. The length of the first shoulder 638 is approximately equal to the first distance D₁. The length of the second shoulder 640 is approximately equal to the second distance D₂. The plate 632 defines a second axis 660 that passes medially through the plate 632 and extends toward and away from the viewer of FIG. 11. The first diffusion opening 642 and the second diffusion opening 644 are disposed on opposing sides of and/or about the second axis 660.

The third diffuser 330, the fourth diffuser 430, the fifth diffuser 530, and the sixth diffuser 630 can be provided in place of either the first diffuser 130 or the second diffuser 230 within the first nozzle outlet subassembly 126 or the second nozzle outlet subassembly 226, respectively, as shown and described.

The sprayer nozzle 100 as described herein as used with any of the diffusers 130, 230, 330, 430, 530, and 630 have been tested to show that drift was reduced by up to 99%. Further, cumulative volume of spray was shown to be improved at about 400 mm, about 500 mm, and about 600 mm heights.

Specific embodiments of an improved sprayer nozzle according to the present disclosure have been described for the purpose of illustrating the manner in which the invention can be made and used. It should be understood that the implementation of other variations and modifications of this invention and its different aspects will be apparent to one skilled in the art, and that this invention is not limited by the specific embodiments described. Features described in one embodiment can be implemented in other embodiments. The subject disclosure is understood to encompass the present invention and any and all modifications, variations, or equivalents that fall within the spirit and scope of the basic underlying principles disclosed and claimed herein.

What is claimed is:

1. A nozzle, comprising:
an elongate body including a first passageway; and
a nozzle outlet subassembly disposed at least partially within the first passageway, the nozzle outlet subassembly including a nozzle terminal and a diffuser, the nozzle terminal defining a second passageway and a spray opening,
wherein the diffuser defines a diffusion opening that is proximate the spray opening.

2. The nozzle of claim 1, wherein the diffuser comprises a plate with the diffusion opening extending through the plate, and a surface of the plate is positioned perpendicular to an axis that extends along at least a portion of the elongate body, through the plate, and through the spray opening.

3. The nozzle of claim 2, wherein the diffusion opening extends through the plate parallel to the axis.

4. The nozzle of claim 2, wherein the diffuser comprises an extender that extends axially from the plate, and the diffuser is positioned in the nozzle outlet subassembly such that the extender extends away from the nozzle terminal.

5. The nozzle of claim 1, wherein the diffusion opening is one of a plurality of diffusion openings defined in the diffuser, the plurality of diffusion openings being disposed about an axis defined by the elongate body and extending through the spray opening.

6. The nozzle of claim 5, wherein one or more of the plurality of diffusion openings has a cross-section that is one of crescent-shaped, semi-circular, or circular.

7. The nozzle of claim 5, wherein one or more of the plurality of diffusion openings is radially offset from the axis.

8. The nozzle of claim 1, wherein the diffuser includes a lobe region extending radially from a central region, and the lobe region and the central region define a shoulder.

9. The nozzle of claim 2, wherein the surface of the plate is seated into the nozzle terminal to orient the diffusion opening relative to the spray opening.

10. A nozzle outlet configured to be coupled to a nozzle, the nozzle outlet comprising:
a nozzle terminal defining a spray opening and an axis extending through the spray opening; and
a diffuser provided in the form of a plate, wherein a diffusion opening extends through the plate and parallel to the axis.

11. The nozzle outlet of claim 10, wherein a surface of the plate is positioned perpendicular to the axis.

12. The nozzle outlet of claim 11, wherein
the axis is a first axis,
the diffusion opening is one of a plurality of diffusion openings aligned along the surface of the plate to form a second axis, and
the first axis is substantially perpendicular to the second axis.

13. The nozzle outlet of claim 10, wherein the diffuser includes a flat side and the flat side mates with the nozzle terminal to orient the diffusion opening relative to the spray opening.

14. The nozzle outlet of claim 11, wherein when the nozzle outlet is viewed from a perspective that is normal to the surface of the plate, an outer circumference of the diffusion opening does not overlap with an outer circumference of the spray opening.

15. The nozzle outlet of claim 10, wherein the diffusion opening has a circular cross-section with a diameter equal to or less than 2 mm.

16. A nozzle comprising:
an elongate body;
a pre-orifice regulator having a pre-orifice opening configured to regulate fluid flow, the pre-orifice regulator being coupled to a first end of the elongate body;
a nozzle terminal coupled to a second end of the elongate body, the nozzle terminal defining a spray opening; and
a diffuser coupled to the nozzle terminal, the diffuser defining a diffusion opening, wherein the diffuser is positioned within the elongate body between the pre-orifice regulator and the spray opening.

17. The nozzle of claim 16, wherein a cross-sectional area of the diffusion opening is larger than a cross-sectional area of the pre-orifice opening.

18. The nozzle of claim 16, wherein the nozzle terminal includes bayonet lobe that mates with the elongate body to align the spray opening relative to the elongate body.

19. The nozzle of claim 16, wherein an axis is defined by the elongate body and extends through the spray opening, and the diffusion opening extends perpendicular to the axis.

20. The nozzle of claim 16, wherein an axis is defined by the elongate body and extends through the spray opening, and the diffusion opening extends parallel to the axis.
